(19) United States
(12) Patent Application Publication
(10) Pub. No.: US 2024/0263798 A1
(43) Pub. Date: Aug. 8, 2024

(54) FIREWOOD STOVE WITH ADJUSTABLE FIREPOWER

(71) Applicant: SHENZHEN ZEJU NETWORK TECHNOLOGY CO., LTD., SHENZHEN (CN)

(72) Inventors: FANQING ZENG, SHENZHEN (CN); JIN WANG, SHENZHEN (CN); SHENGHAO WANG, SHENZHEN (CN)

(21) Appl. No.: 18/105,289

(22) Filed: Feb. 3, 2023

(51) Int. Cl. F24B 1/19; F23M 9/02

(52) U.S. Cl. CPC F24B 1/19; F23M 9/02

(57) ABSTRACT

The present disclosure provides a firewood stove with adjustable firepower, wherein an air inlet barrel is provided outside a combustion barrel, an inner bottom wall of the air inlet barrel is provided with a protrusion, an outer bottom wall of the combustion barrel is provided with an accommodating groove, and the protrusion is provided through the accommodating groove. The top end of the outer wall of the combustion barrel is provided with a baffle plate, and the baffle plate abuts against the inner wall of the air inlet barrel. The bottom wall of the combustion barrel is provided with a first ventilation hole, and the air inlet barrel is provided with an air inlet hole. Through the above technical solution, the problem that the firepower of the existing firewood stove cannot be adjusted due to the size of the air inlet barrel cannot be adjusted is solved.

### TECHNICAL FIELD

The present disclosure relates to a technical field of a firewood stove, and in particular to a firewood stove with adjustable firepower.

### BACKGROUND

Firewood stoves are heating or cooking equipment that provide heat energy by burning firewood, wood, biological particles, charcoal and other fuels. Firewood stoves are the common daily appliance in people's life, especially in the wild or rural areas. Because of the wide source of firewood, firewood stoves are preferred by many tourists, and often used in the field environment. In order to clean the ash out of the firewood stove, the ash can only be cleared from the firewood stove by shoveling the ash, which results in heavy work and dirty ash removal. In addition, since the size of the air inlet barrel of the existing firewood stove cannot be adjusted, the fire power of the existing firewood stove cannot be adjusted.

### SUMMARY

The present disclosure proposes a firewood stove with adjustable firepower, solves the problem that the firepower of existing firewood stoves cannot be adjusted because the size of the air inlet cannot be adjusted.

The technical solution of the present disclosure is as follows:

The firewood stove with adjustable firepower, comprising: an air inlet barrel (1), a combustion barrel (2) and an air inlet valve (3), the air inlet barrel (1) is provided outside the combustion barrel (2), an inner bottom wall of the air inlet barrel (1) is provided with a protrusion (4), an outer bottom wall of the combustion barrel (2) is provided with an accommodating groove (5), the protrusion (4) is penetrating into the accommodating groove (5), the outer bottom wall of the combustion barrel (2) is spaced apart from the inner bottom wall of the air inlet barrel (1) by means of the protrusion (4) and the accommodating groove (5), a top end of the outer wall of the combustion barrel (2) is provided with a baffle plate (6), and the baffle plate (6) abuts against the inner wall of the air inlet barrel (1), the side wall of the combustion barrel (2) is spaced apart from the side wall of the air inlet barrel (1) by means of the baffle plate (6), the bottom wall of the combustion barrel (2) is provided with a first ventilation hole (7), and the air inlet barrel (1) is provided with an air inlet hole (8), the air inlet valve (3) is located inside the air inlet barrel (1), and the adjustment of the air inlet cross-sectional area of the air inlet hole (8) is achieved by means of rotation of the air inlet valve (3).

Furthermore, an air vent (9) is provided on the air inlet valve (3), and the air inlet valve (3) realizes the connection or avoidance between the air vent (9) and the air inlet hole (8) by means of the rotation of the air inlet valve (3).

Furthermore, the air inlet valve (3) is provided with a handle (10), and the end of the handle (10) is present outside the air inlet barrel (1) after passing through the air inlet hole (8).

Furthermore, a groove (11) is provided on an inner wall of one side of the air inlet hole (8), and the handle (10) passes through the groove (11).

Furthermore, the air inlet barrel (1) and the combustion barrel (2) are both barrel-shaped, the air inlet valve (3) is annular, and the air vent (9) penetrates a side wall of the air inlet valve (3).

Furthermore, the number of the air vents (9) is multiple and uniformly distributed in the circumference.

Furthermore, the number of the air inlet holes (8) is the same as the number of the air vent (9) and is arranged in a one-to-one correspondence.

Furthermore, a second ventilation hole (12) is provided above the side of the combustion barrel (2).

Furthermore, the number of the second ventilation holes (12) is multiple and uniformly distributed in the circumference.

Furthermore, an upper cover (13) is provided at the top end of the combustion barrel (2) and is provided with a through hole, the through hole is connected to the inside of the combustion barrel (2).

The present disclosure has beneficial effects as follows: compared with the prior art, the air inlet barrel (1) is provided outside the combustion barrel (2), an inner bottom wall of the air inlet barrel (1) is provided with a protrusion (4), an outer bottom wall of the combustion barrel (2) is provided with an accommodating groove (5), the protrusion (4) is penetrating into the accommodating groove (5), in addition, the outer wall of the combustion barrel (2) is provided with a baffle plate (6). When the combustion barrel (2) is placed in the air inlet barrel (1), the protrusion on the air inlet barrel (1) will penetrate into the accommodating groove (5) on the combustion barrel (2), and the baffle on the combustion barrel (2) will abut against the inner wall of the side of the air inlet barrel (1), so that there is a gap between the air inlet barrel (1) and the combustion barrel (2); the bottom wall of the combustion barrel (2) is provided with a first ventilation hole (7), and the air inlet barrel (1) is provided with an air inlet hole (8). After the air inlet valve (3) is rotated, the air inlet hole (8) can intake air, and the air enters the air inlet barrel (1) and then enters the combustion barrel (2) from the first ventilation hole (7) for combustion of the fuel in the combustion barrel (2). By rotating the air inlet valve (3), the size of the cross-sectional area of the inlet air can be adjusted, and thus the size of the fire can be adjusted. Since the combustion barrel (2) and the air inlet barrel (1) are separable, the combustion barrel (2) can be lifted out and the slag in the barrel can be dumped after use.

### BRIEF DESCRIPTION OF DRAWINGS

In order to more clearly illustrate technical solutions in embodiments of the present disclosure, drawings required in description or prior art are briefly introduced below, and obviously, the drawings in the following description are merely some embodiments of the present disclosure. For a person having ordinary skill in art, other drawings may be obtained according to the drawings without creative efforts.

FIG. 1 is a schematic view showing the overall structure of firewood stove with adjustable firepower;

FIG. 2 is an exploded view of FIG. 1;

FIG. 3 is a semi-sectional view of FIG. 1;

FIG. 4 is the structural view of FIG. 3 with the air inlet barrel hidden.

### REFERENCE NUMBER IN THE DRAWINGS

| | | | |
|---|---|---|---|
| air inlet barrel | 1 | combustion barrel | 2 |
| air inlet valve | 3 | protrusion | 4 |
| accommodating groove | 5 | baffle plate | 6 |
| first ventilation hole | 7 | air inlet hole | 8 |
| air vent | 9 | handle | 10 |
| groove | 11 | second ventilation hole | 12 |
| upper cover | 13 | | |

### DETAILED DESCRIPTION

The following describes in detail the embodiments of the present disclosure, examples of which are illustrated in the accompanying drawings, wherein the same or similar reference numerals refer to the same or similar elements or elements having the same or similar functions throughout. The embodiments described below with reference to the accompanying drawings are exemplary, and are not intended to limit the present disclosure.

In order to make the purpose, technical solutions, and advantages of the present disclosure clear, the following further describes the present disclosure in detail with reference to accompanying drawings and embodiments.

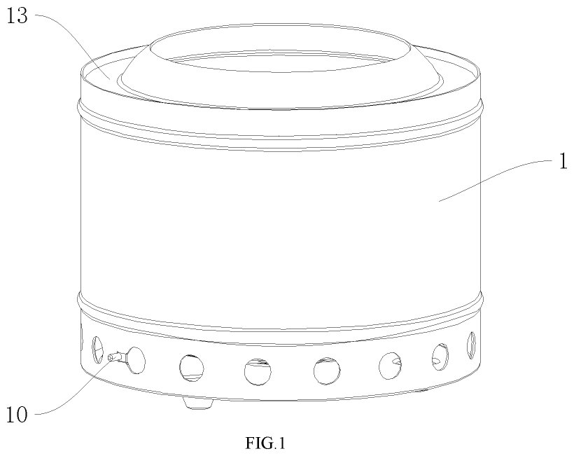

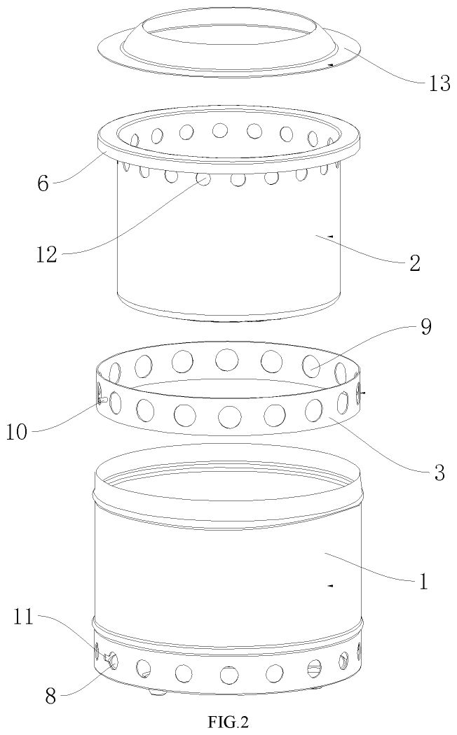

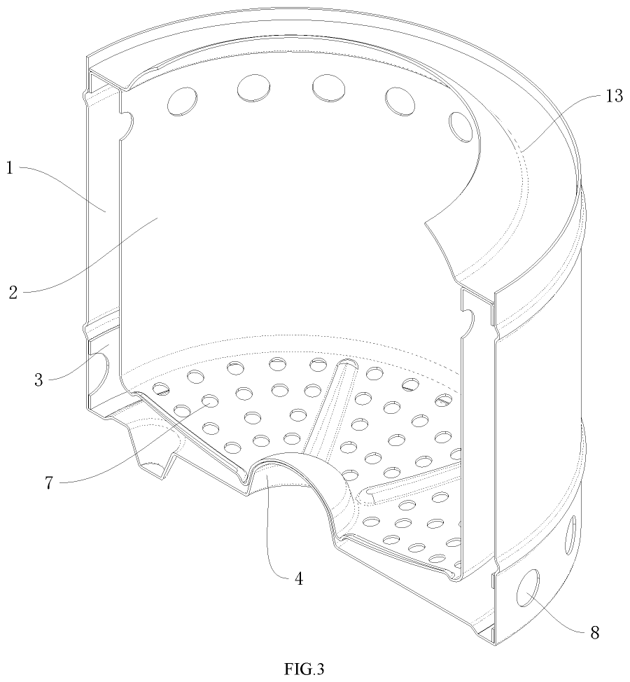

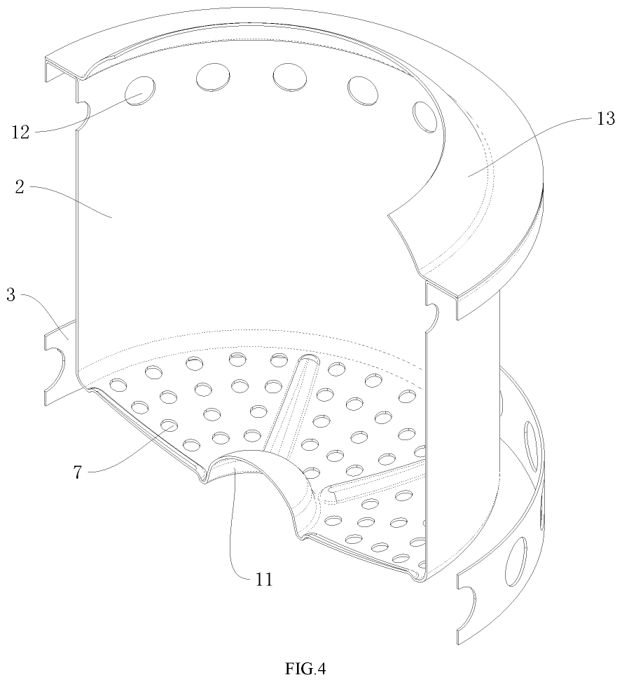

Referring to FIG. 1, FIG. 2, FIG. 3 and FIG. 4, the present disclosure provides a firewood stove with adjustable firepower, comprising: an air inlet barrel (1), a combustion barrel (2) and an air inlet valve (3), the air inlet barrel (1) is provided outside the combustion barrel (2), an inner bottom wall of the air inlet barrel (1) is provided with a protrusion (4), an outer bottom wall of the combustion barrel (2) is provided with an accommodating groove (5), the protrusion (4) is penetrating into the accommodating groove (5), the outer bottom wall of the combustion barrel (2) is spaced apart from the inner bottom wall of the air inlet barrel (1) by means of the protrusion (4) and the accommodating groove (5), a top end of the outer wall of the combustion barrel (2) is provided with a baffle plate (6), and the baffle plate (6) abuts against the inner wall of the air inlet barrel (1), the side wall of the combustion barrel (2) is spaced apart from the side wall of the air inlet barrel (1) by means of the baffle plate (6), the bottom wall of the combustion barrel (2) is provided with the first ventilation hole (7), and the air inlet barrel (1) is provided with an air inlet hole (8), the air inlet valve (3) is located inside the air inlet barrel (1), and the adjustment of the air inlet cross-sectional area of the air inlet hole (8) is achieved by means of rotation of the air inlet valve (3).

In this embodiment, the air inlet barrel (1) is provided outside the combustion barrel (2), an inner bottom wall of the air inlet barrel (1) is provided with the protrusion (4), an outer bottom wall of the combustion barrel (2) is provided with the accommodating groove (5), the protrusion (4) is penetrating into the accommodating groove (5), in addition, the outer wall of the combustion barrel (2) is provided with the baffle plate (6). When the combustion barrel (2) is placed in the air inlet barrel (1), the protrusion on the air inlet barrel (1) will penetrate into the accommodating groove (5) on the combustion barrel (2), and the baffle on the combustion barrel (2) will abut against the inner wall of the side of the air inlet barrel (1), so that there is a gap between the air inlet barrel (1) and the combustion barrel (2); the bottom wall of the combustion barrel (2) is provided with the first ventilation hole (7), and the air inlet barrel (1) is provided with the air inlet hole (8). After the air inlet valve (3) is rotated, the air inlet hole (8) can intake air, and the air enters the air inlet barrel (1) and then enters the combustion barrel (2) from the first ventilation hole (7) for combustion of the fuel in the combustion barrel (2). By rotating the air inlet valve (3), the size of the cross-sectional area of the inlet air can be adjusted, and thus the size of the fire can be adjusted. Since the combustion barrel (2) and the air inlet barrel (1) are separable, the combustion barrel (2) can be lifted out and the slag in the barrel can be dumped after use.

It should be noted that when the air inlet valve (3) is rotated, the air inlet valve (3) can cover and avoid the air inlet hole (8) of the air inlet barrel (1) by 100%.

Referring to FIG. 2, FIG. 3 and FIG. 4, the present disclosure provides an air vent (9) is provided on the air inlet valve (3), and the air inlet valve (3) realizes the connection or avoidance between the air vent (9) and the air inlet hole (8) by means of the rotation of the air inlet valve (3).

In this embodiment, in order to facilitate the operation of the air inlet valve (3), the air vent (9) is provided on the air inlet valve (3), and when the air inlet valve (3) is rotated, the air vent (9) can achieve communication with the air vent (9), thereby achieving the adjustment of the air inlet cross-sectional area of the air inlet hole (8) by the air inlet valve (3).

Referring to FIG. 1, FIG. 2 and FIG. 3, the present disclosure provides the air inlet valve (3) is provided with a handle (10), and the end of the handle (10) is present outside the air inlet barrel (1) after passing through the air inlet hole (8).

In the embodiment, in order to facilitate the operator's operation without the aid of tools, the handle (10) is provided on the air inlet valve (3), and the end of the handle (10) passes through the air inlet hole (8) and leaks outside the air inlet barrel (1), and can be rotated by the handle (10) when the air inlet valve (3) needs to be rotated.

It should be noted that in order to install the air inlet valve (3) with the handle (10) into the air inlet barrel (1), the handle (10) and the air inlet valve (3) are detachably connected. Alternatively, the air inlet valve (3) is fitted into the air inlet barrel (1), and then the handle (10) is fixed to the air inlet valve (3) in a non-detachable manner.

Referring to FIG. 1, FIG. 2 and FIG. 3, the present disclosure provides a groove (11) is provided on an inner wall of one side of the air inlet hole (8), and the handle (10) passes through the groove (11).

In the embodiment, since the handle (10) passes through the air inlet hole (8), in order to avoid the influence of the handle (10) on the maximum area of the air inlet hole (8), the groove (11) is provided on one side of the inner wall of the air inlet hole (8), and the handle (10) is always located in the groove (11) during the whole rotation, so that the sizes of the air inlet hole (8) and the air vent (9) can be set in a uniform manner.

Referring to FIG. 1, FIG. 2, FIG. 3 and FIG. 4, the present disclosure provides the air inlet barrel (1) and the combustion barrel (2) are both barrel-shaped, the air inlet valve (3) is annular, and the air vent (9) penetrates a side wall of the air inlet valve (3).

In the embodiment, in order to facilitate carrying and manufacturing, the air inlet barrel (1) and the combustion barrel (2) are arranged in a round barrel shape, the air inlet valve (3) is annular, the air vent (9) penetrates through a side wall of the air inlet valve (3), a bottom wall of the air inlet valve (3) is in contact with an inner bottom wall of the air inlet barrel (1), and the air inlet valve (3) is located in the air inlet barrel (1) by means of self-weight.

In addition, the air inlet barrel (1) and the combustion barrel (2) are formed by spinning, so that the use of a welding process is avoided, and the process is simple and the cost is low.

Referring to FIG. 1, FIG. 2, FIG. 3 and FIG. 4, the present disclosure provides the number of the air vents (9) is multiple and uniformly distributed in the circumference. The number of the air inlet holes (8) is the same as the number of the air vent (9) and is arranged in a one-to-one correspondence.

In the embodiment, since the wind direction is changed in the field, in order to realize that the wind enters the firewood stove without moving the firewood stove, the number of the air inlet holes (8) and the air vents (9) are provided in several numbers and are uniformly distributed in the circumference, and the number of the air inlet holes (8) is the same as the number of the air vents (9) and is provided in a one-to-one corresponding manner. At this time, it is possible to choose only one air inlet holes (8) with the groove (11) and then to provide the handle (10) on the air inlet valve (3). Viewed along the rotation path of the air inlet valve (3), the path length between adjacent air inlet holes (8) must be greater than the path length of a single air inlet holes (8), and also greater than the path length of the air vents (9), namely, after rotation, the barrel wall between adjacent air inlet holes (8) can completely block the air vents (9).

Referring to FIG. 2, FIG. 3 and FIG. 4, the present disclosure provides a second ventilation hole (12) is provided above the side of the combustion barrel (2). In the embodiment, in order to achieve full combustion of the fuel in the firewood stove, air can be re-introduced above the flame, namely, the second ventilation hole (12) is opened above the side of the combustion barrel (2), and the external air enters the combustion barrel (2) from the first ventilation hole (7) and the second ventilation hole (12) after passing through the air inlet holes (8) and the air vents (9) respectively.

Referring to FIG. 1, FIG. 2, FIG. 3 and FIG. 4, the present disclosure also provides the number of the second ventilation holes (12) is multiple and uniformly distributed in the circumference.

In the embodiment, in the present embodiment, in order to ensure that more air is introduced into the combustion barrel (2) from all directions, the second ventilation hole (12) are provided in several numbers and in a circumferentially uniform manner.

It should be specifically mentioned that the shapes of the air inlet holes (8), the air vents (9), the first ventilation hole 7 and the second ventilation hole 12 are various common hole forms, wherein the air inlet holes (8), the air vents (9), the first ventilation hole (7) and the second ventilation hole (12) are provided as circular holes for the convenience of processing.

Referring to FIG. 1, FIG. 2, FIG. 3 and FIG. 4, the present disclosure provides an upper cover (13) is provided at the top end of the combustion barrel (2) and is provided with a through hole, the through hole is connected to the inside of the combustion barrel (2).

In the embodiment, in order to facilitate the placement of pots of various specifications on the firewood stove, the upper cover (13) is provided at the top of the combustion barrel (2), the upper cover (13) is provided with a through hole, and the firewood stove can heat the pots when the pots are seated on the upper cover (13).

Above are only preferred embodiments of the present disclosure and are not intended to limit the present disclosure. Any modification, equivalent replacement and improvement made within spirit and principle of the present disclosure should be included in protective scope of the present disclosure.

What is claimed is:

1. A firewood stove with adjustable firepower, comprising:
an air inlet barrel (1), a combustion barrel (2) and an air inlet valve (3), the air inlet barrel (1) is provided outside the combustion barrel (2), an inner bottom wall of the air inlet barrel (1) is provided with a protrusion (4), an outer bottom wall of the combustion barrel (2) is provided with an accommodating groove (5), the protrusion (4) is penetrating into the accommodating groove (5), the outer bottom wall of the combustion barrel (2) is spaced apart from the inner bottom wall of the air inlet barrel (1) by means of the protrusion (4) and the accommodating groove (5), a top end of the outer wall of the combustion barrel (2) is provided with a baffle plate (6), and the baffle plate (6) abuts against the inner wall of the air inlet barrel (1), the side wall of the combustion barrel (2) is spaced apart from the side wall of the air inlet barrel (1) by means of the baffle plate (6), the bottom wall of the combustion barrel (2) is provided with a first ventilation hole (7), and the air inlet barrel (1) is provided with an air inlet hole (8), the air inlet valve (3) is located inside the air inlet barrel (1), and the adjustment of the air inlet cross-sectional area of the air inlet hole (8) is achieved by means of rotation of the air inlet valve (3).

2. The firewood stove with adjustable firepower of claim 1, wherein an air vent (9) is provided on the air inlet valve (3), and the air inlet valve (3) realizes the connection or avoidance between the air vent (9) and the air inlet hole (8) by means of the rotation of the air inlet valve (3).

3. The firewood stove with adjustable firepower of claim 2, wherein the air inlet valve (3) is provided with a handle (10), and the end of the handle (10) is present outside the air inlet barrel (1) after passing through the air inlet hole (8).

4. The firewood stove with adjustable firepower of claim 3, wherein a groove (11) is provided on an inner wall of one side of the air inlet hole (8), and the handle (10) passes through the groove (11).

5. The firewood stove with adjustable firepower of claim 4, wherein the air inlet barrel (1) and the combustion barrel (2) are both barrel-shaped, the air inlet valve (3) is annular shaped, and the air vent (9) penetrates a side wall of the air inlet valve (3).

6. The firewood stove with adjustable firepower of claim 5, wherein the number of the air vents (9) is multiple and uniformly distributed in the circumference.

7. The firewood stove with adjustable firepower of claim 6, wherein the number of the air inlet holes (8) is the same as the number of the air vents (9) and is arranged in a one-to-one correspondence.

8. The firewood stove with adjustable firepower of claim 7, wherein a second ventilation hole (12) is provided above the side of the combustion barrel (2).

9. The firewood stove with adjustable firepower of claim 8, wherein the number of the second ventilation holes (12) is multiple and uniformly distributed in the circumference.

10. The firewood stove with adjustable firepower of claim 1, wherein an upper cover (13) is provided at the top end of the combustion barrel (2) and is provided with a through hole, the through hole is connected to the inside of the combustion barrel (2).
